(19) United States
(12) Patent Application Publication
(10) Pub. No.: US 2019/0108600 A1
(43) Pub. Date: Apr. 11, 2019

(54) Optimized Operation Method in Micro-Grid with Multi Agent Structure

(71) Applicant: Tianjin University, Tianjin (CN)

(72) Inventors: Xiangyu KONG, Tianjin (CN); Shengchen WANG, Tianjin (CN)

(73) Assignee: Tianjin University, Tianjin (CN)

(21) Appl. No.: 15/526,738

(22) PCT Filed: Apr. 26, 2015
(86) PCT No.: PCT/CN2015/077471

§ 371 Date: May 12, 2017

(30) Foreign Application Priority Data
Nov. 19, 2014 (CN) 201410668588.8

(51) Int. Cl. G06Q 50/06; G05B 13/04; G06Q 40/04; H02J 3/00

(52) U.S. Cl. CPC G06Q 50/06; G05B 13/041; H02J 3/383; H02J 3/008; G06Q 40/04

(57) ABSTRACT

The present invention discloses an optimized operation method in micro-grid with multi-agent structure, which comprises the following steps: the main grid obtains the electricity market purchase price P_{buy} which is to be sold to the user and DER selling price Pₛₑₗₗ at next stage after connected to the main grid; the DERs perform calculation of the optimized operation in the micro-grid based on bidding; the DERs of the micro-grid adopt bidding unit for quotation; and the bidding management Agent assists in completing the coordination and optimization of the units in the micro-grid; the bidding management multi-agent transmits the bidding results of each unit to the control system of the micro-grid, and the micro-grid performs optimized operation in micro-grid based on the coordinated bidding results. The present invention solves the existing problem of conflicting in interest distribution inside the micro-grid when devices therein belong to different owners or when public micro-grid is involved, and assists the achievement of the micro-grid commercial operation.

### FIELD OF THE INVENTION

The present invention belongs to the technical field of power system, and more particular, relates to an optimized operation method in micro-grid with multi-agent structure.

### BACKGROUND OF THE INVENTION

As an organization of distributed energy resource (DER), people have shown great concern in micro-grid, and the optimized operation in micro-grid is become a hotspot of research. Multi-Agent Systems (MAS) is suitable for resolving complicated and open distributed problems, thus is widely used in the operation in micro-grid, the techniques thereof draw a certain focus and obtain a certain achievements.

Currently micro-grid optimized operation based on MAS structure mostly aims at the minimization of cost based on power generation and maintenance of network equipment and mutual purchase of electric energy with main grid. Based on voluntary cooperation, the agents normally cooperate completely with each other to jointly finish the task in solving problems. The existing operation mode is easy and practical when devices therein belong to a same owner. With the development of micro-grid marketization, this kind of operation mode has difficulty in coordinating interest distribution inside the micro-grid especially when devices therein belong to different owners, such as a micro-grid formed by a plurality of hotels. In the open market, each DER in the micro-grid allows having its own aim and interest, participating operation in micro-grid with intend. Currently voluntary cooperation of the micro-grid is just a special situation of agents interaction.

In the future, an important manner of micro-grid commercial operation is to introduce the subjects in the micro-grid to participate workable competition via bidding market mechanism. Combining the bidding method with controlling method of micro-grid, the power generation bidding method may well reflect the decentralized decisions of DERs, and the price coordination can be also introduced into the method to achieve centralized management. In view of characteristics of DERs and micro-grid, the existing research results of the normal electricity market cannot directly apply to the micro-grid, the following problems exist when adopt existing bidding in operation of the micro-grid:

Normal electricity market bidding is usually taken as an independent system, i.e., the individual power producer generates a quotation according to its own bidding strategy and operation, the offers then are collected to the electricity market administration for bidding and forming the generation scheme. These steps are apart from the operational control of the power system. Whereas, in the micro-grid based on MAS, the operation strategy is achieved by individual agents, the bidding result will be transmitted directly to the agents of micro-grid operational control for performing and therefore, bidding function should be incorporated into entire structure of MAS operation control instead of a separate design.

Power generation bidding of the distributed energy resource inside the micro-grid is a complex system and is influenced by various factors such as market and technologies. DERs, such as wind energy and solar photovoltaic power generation, have the disadvantages of intermittence and uncontrollability, and complex operation environment. In addition, it is hard to obtain bidding sample under all modes by means of actual observation or by means of analysis and simulation of actual system. Presently conventional bidding algorithms such as “reinforcement learning” and “repeat game” are unable to achieve satisfying result of bidding under unknown environment. In the micro-grid, as bidding result will directly guide operational control, seemingly “reasonable” bidding agent may seem to be “awkward” when facing unexpected events and this is unacceptable.

For overcoming the above-mentioned problems, the present invention aims at adding distributed bidding function in the existing operational control of micro-grid, reflecting the interests of the participators of the micro-grid and guiding the micro-grid optimized operation; meanwhile, the present invention takes the self adaptation and defect tolerance of artificial immune systems (AIS) in the process of bidding to handle the uncertain problems produced by power intermittency, and improves the coordination of MAS according to co-evolution of this method.

### SUMMARY OF THE INVENTION

The present invention provides an optimized operation method in the micro-grid with multi-agent structure. It can solve the existing problem of conflicting in interest distribution inside the micro-grid especially when devices therein belong to different owners or when public micro-grid is involved. The present method provides guidance to optimized operation of the micro-grid by market mechanism of bidding. The method is described as follows.

An optimized operation method in micro-grid with multi-agent structure comprises the following steps:

The main grid obtains the electricity market purchase price P_{buy} which is to be sold to the user and DER selling price Pₛₑₗₗ at next stage after connected to the main grid;

The DERs perform calculation of the optimized operation in the micro-grid based on bidding strategy; the DERs of the micro-grid adopt bidding unit for quotation; and the bidding management multi-agent assists in the completion of coordination and optimization of units in the micro-grid;

The bidding management multi-agent transmits the bidding results of each unit to the control system of the micro-grid, and the micro-grid performs optimized operation in micro-grid based on the coordinated bidding results.

The steps of “the DERs of the micro-grid adopts bidding unit for quotation” comprise:

Determining affinity formula of artificial immune algorithm based on the objective function of the DER bidding unit, and forming a quotation environmental antigen of artificial immunity;

Solving the artificial immune algorithm and obtaining the antibody in accordance with the interest of DER, and decoding the antibody to achieve the bidding schemes of DER and submitting it to the bidding management multi-agent.

The steps of “the bidding management multi-agent assists in the completion of coordination and optimization of units in the micro-grid” comprise:

Determining whether the resources and loads of DER in micro-grid are balanced;

If yes, recording the bidding information of DERs, generating the generator operation scheme and submitting it to the control system of micro-grid;

Otherwise, performing bidding until the resources and loads of DER in micro-grid achieves balance.

The steps of “determining affinity formula of artificial immune algorithm based on the objective function of the DER bidding unit, and forming a quotation environmental antigen of artificial immunity” comprise:

Based on the bidding modes of the micro-grid, determining the quotation mode and bidding objective function by the owners of DERs;

Based on the characteristics of DER, determining the forms of antigen of artificial immune algorithm by the bidding unit multi-agent;

Based on the quotation mode of DER, determining antibody, encoding and decoding formulas of antibody of artificial immune algorithm by the bidding unit multi-agent;

Based on the objective function of the DER bidding unit, determining affinity formula of artificial immune algorithm by the bidding unit multi-agent; and

Processing the collected information by the bidding unit multi-agent to achieve the quotation environmental antigen.

Wherein, the form of antigen comprises the followings three information:

(a) Environmental information of the bidding equipments;

(b) The electricity purchase price obtained by the main grid and the selling price which is to be sold to the main grid within the optimized operation period;

(c) Quotation of other bidding unit multi-agent t.

The determination condition depends on whether reaching the maximum processing number, and/or the clearance price inside the micro-grid unchanged.

The technical scheme of the present invention brings the following good effects.

(1) For the future development of electric power market and micro-grid, micro-grid may belong to different owners and it is unavoidable to perform optimized operational control based on economic means such as bidding. The present invention can solve the problems such as conflict in interest distribution inside the micro-grid especially when devices therein belong to different owners or when public micro-grid is involved, thus being helpful to realize the commercialized operation of micro-grid.

(2) The present invention utilizes optimized bidding operation and control method of MAS to reflect the interests of the participators of the respective micro-grids with market means and to guide the micro-grid optimization with bidding results, thus meeting the requirements of delaminating and distributing control of micro-grid. As for the DER or controllable load units, the controller embedded the programmable multi-agent of the present invention according to MAS standards can achieve plug and play and directly participate optimized bidding operation.

### BRIEF DESCRIPTION OF THE DRAWINGS

FIG. 1 shows a control frame of the optimized operation inside the micro-grid based on bidding;

FIG. 2 shows an operation time flowchart of the optimized operation inside the micro-grid;

FIG. 3 shows a bidding feedback and co-evolution solution of the micro-grid of the present invention;

FIG. 4 shows a form of antigen performed by a bidding unit based on artificial immunity of the present invention;

FIG. 5 shows an optimized algorithm flowchart of a bidding unit Agent based on artificial immunity of the present invention;

FIG. 6 shows a form of the bidding feedback of the embodiment of the present invention;

FIG. 7 shows an AIS model frame based on coordinated evolution of the embodiment of the present invention;

FIG. 8 shows a micro-grid structure of the embodiment of the present invention;

FIG. 9 shows a schematic view illustrating the variation trend of antibody affinity of the bidding unit Agent during bidding process according to the embodiment of the invention;

FIG. 10 shows the clearance price over a bidding duration after several times of coordination in the micro-grid according to the embodiment of the invention;

FIG. 11 shows an evolved generation distribution of the bidding unitAgent after solving for 5000 times; and

FIG. 12 shows the generation distribution of coordinated evolution after micro-grid's solving for 100 times to achieve a Nash Equilibrium.

### DETAILED DESCRIPTION OF THE INVENTION

To make better understand of the objects, solution and advantages of the invention, the present invention will be further described in detail combining with specific embodiments.

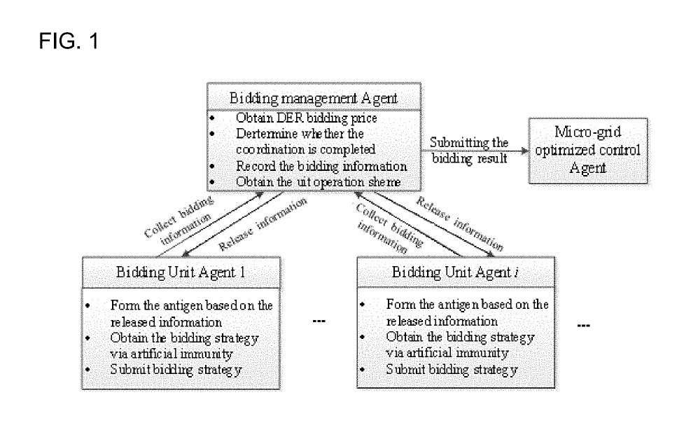

In order to overcome the interest distribution of the respective units inside the micro-grid when devices therein belong to different owners during commercial operation of the micro-grid, and to meet the requirements of delaminating and distributing control of micro-grid, and to contain a multiple types of DERs with intermittent and uncontrollable characteristics, the present invention provides an optimized operation method in micro-grid with multi-agent structure as shown in FIG. 1 to FIG. 12. The details are as follows:

A. Structure of Optimized Operation in Micro-Grid and the Setting of Agents

The optimized operation structure of micro-grid based on DER bidding method is shown in FIG. 1, which mainly includes optimized control Agent of micro-grid, bidding management Agent and bidding unit Agent, each of the Agent has the following features:

(1) Optimized Control Agent of Micro-Grid:

The optimized control Agent sends the current operation conditions of the micro-grid to the bidding management Agent, and receives the returned information of generation and the load energy balance from the bidding management Agent. Besides the controlling of energy management of the micro-grid, the optimized control Agent monitors the data of the micro-grid, such as internal voltage, power quality and frequency. In a particular case, such as blackout catastrophes of large power network occurred or the grid-connection transformed to operation independently, the optimized control Agent directly controls the load and output management of distributed power generation inside the micro-grid, and ignores the returned information from the bidding management Agent.

(2) Bidding Management Agent:

The bidding management Agent assists the optimized control Agent to complete the economic generation distribution, and represents the main grid to release electric purchase price/selling price of overall load and Agents of DER units inside the micro-grid, and manages the invitation and tender information of Agents of DER units inside the micro-grid. The bidding interval, normally 15 minutes per duration, keeps pace with the bidding time accessed to the power grid. The main function of the bidding management Agent are: obtaining the generating bidding price of respective DER, determining whether the coordination is finished or not, recording the bidding information and obtaining the operation scheme of units.

(3) Bidding Unit Agent

The bidding unit agent mainly is the DER unit, and can comprise load unit Agent in some certain circumstances. The DER unit Agent, e.g. the energy source unit, such as photovoltaic cells, wind turbines, fuel cells and micro turbines, provides power to the micro-grid. The DER unit Agent submits the generation bidding request for every 15 minutes to the bidding management Agent according to the local measuring information and communication information communicated between DER unit Agent and other Agents.

The load unit mainly comprises the load required by residence, business or industry inside the micro-grid. Similar to DER unit, the load unit is capable of submitting the expected power to be obtained and the affordable ceiling and floor price for every 15 minutes, but the load unit shall be not involved with bidding. The energy storage device can be considered as an energy resource or a load device, which can provide a quotation according to the DER when discharging and can tender according to the load when charging. The main functions of the load unit are: forming antigen according to the released information, obtaining the bidding strategy via artificial intelligent method and submitting the bidding strategy.

The solution and achievement of the above bidding functions of micro-grid depend on the coordinated evolution of MAS and the self-adaptivity and strong search ability of unit control algorithm. As for the communication, the general technique of MAS system may be adopted for communication, the bidding management

Agent collects the bidding information provided by the respective bidding Agents by way of inquiry, and releases the information by blackboard system.

B. Workflow of Optimized Operation of the Micro-Grid

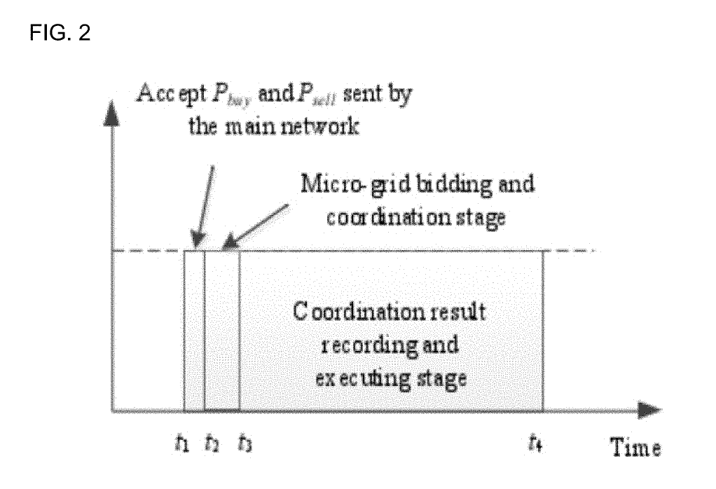

The idea of controlling the optimized operation of the micro-grid is as follows: on the basis of the research results of the current MAS control system, the present invention adds the function of bidding Agent based on the current system, and transfers the bidding results to the control Agent for optimized operation. There are two types of micro-grid, which are independent micro-grid and grid-connection micro-grid. The operation time flowchart of the optimized operation inside the micro-grid according to the embodiment is shown as FIG. 2.

The main operation time flowchart comprises:

(1) The main grid obtains the electricity market purchase price P_{buy} which is to be sold to the user and DER selling price Pₛₑₗₗ at next stage after connected to the main grid;

(2) The individual DERs perform calculation of the optimized operation of the micro-grid based on the self economic interests inside the micro-grid. In the process, the DERs of the micro-grid adopt bidding unit Agent for achieving the quotation; and the bidding management Agent assists in the completion of coordination and optimization of units in the micro-grid;

(3) The bidding management Agent transmits the bidding results of each Agent to the operation Agent, the micro-grid records the coordinated bidding result, and performs optimized operation in micro-grid.

C. Bidding Feedback and Coordinated Evolution Solution in the Bidding Process of the Micro-Grid

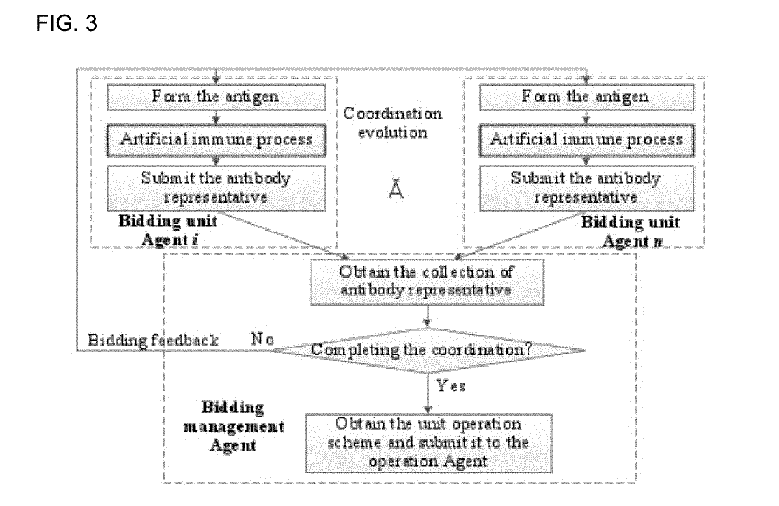

The key parts of the DER bidding algorithm of the micro-grid based on the artificial Immune system are the unit Agent adaptive immune algorithm and the achievements of the coordinated evolution of the respective Agents on the basis of the algorithm. The bidding feedback and coordinated evolution solution of the micro-grid is shown in FIG. 3, the technical scheme comprises: considering the bidding unit DER as an Agent with perceptual and rational thinking, performing interaction among the agents by the submitted bidding information (e.g. antibody representative), and achieving the resources coordination between the resources and the loads and among the power supplies inside the micro-grid by the bidding feedback provided by the bidding management Agent.

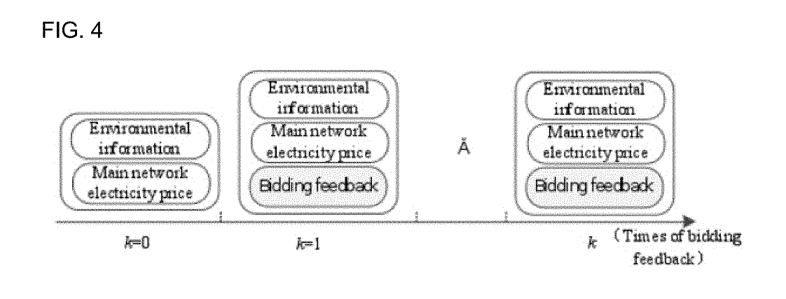

One artificial immune solving process of the bidding unit Agent is a bidding process, and the form of antigen adopted by the bidding unit in the bidding process is shown in FIG. 4. In a bidding stage, DER bidding unit takes self environmental information and main grid electricity purchase information as the antigen and performs artificial immune antibody solving to obtain the bidding price; then the bidding management Agent collects the bidding information and releases it to the respective bidding unit Agents by ways of bidding feedback; the bidding unit Agents generate new antigens based on the feedback information and to obtain a bidding strategy after calculation; and a final quotation will be obtained after performing a plurality of feedbacks and coordination.

Wherein, the permitted number of feedback determines the number of the coordinated evolution of artificial immunity; the contents of bidding feedbacks determine the form of antigen of the artificial immune algorithm. Different types of the bidding modes may be different from each other.

(1) Set k to represent the maximum permissible bidding times of feedback and amending the bidding price of the bidding units of micro-grid, if the feedback is not permitted by the micro-grid, then set k=0; if multiple feedbacks are permitted by the micro-grid to achieve the coordination of resources and demand, then k is not constrained. Normally, after a few times the feedback can achieve Nash equilibrium.

(2) When the bidding with feedback is permitted, the contents of the bidding feedback received by the bidding unit may be clearance price p_{cl} or the bidding information of the respective bidding units. The differences is that the p_{cl} as the feedback information is obtained by bidding management Agent, when the Agent occurs error, the whole bidding function may breakdown; whereas when the feedback information is the bidding information of the respective bidding units, the DER bidding units require a larger amount of calculation to analyze the quotation and give its own optimal bidding strategy. Furthermore, the bidding information of the respective bidding units can be obtained by collecting and releasing by the bidding management Agent, or obtained by information interacting among the respective bidding unit Agents, which is more suitable for future distributed micro-grid control method.

In order to adapt the present invention to the principle of universality, the embodiment adopts permitting multiple feedbacks during the bidding process of the micro-grid (k is an integer greater than 1), the feedbacks are the quotation of the respective bidding unit. The other types of the market bidding environment can adopt the same method as mentioned above, the specific form of antigen and the maximum permitted feedback times during the bidding process shall not affected the application of the present method.

Wherein, the information of bidding feedbacks is the only way and contents interacted among the Agents, the embodiment adopts the bidding information of the respective bidding unit Agents. The initial value of the bidding information may be reflected by the real operating costs, or may be a bidding information made by a bidding strategy. Under the direction of the presented affinity, the bidding process is to obtain an optimized value based on the artificial immune algorithm. Within a same operating control time period, the bidding price submitted by the Agents are varied with iteration, thus the antigen is dynamic.

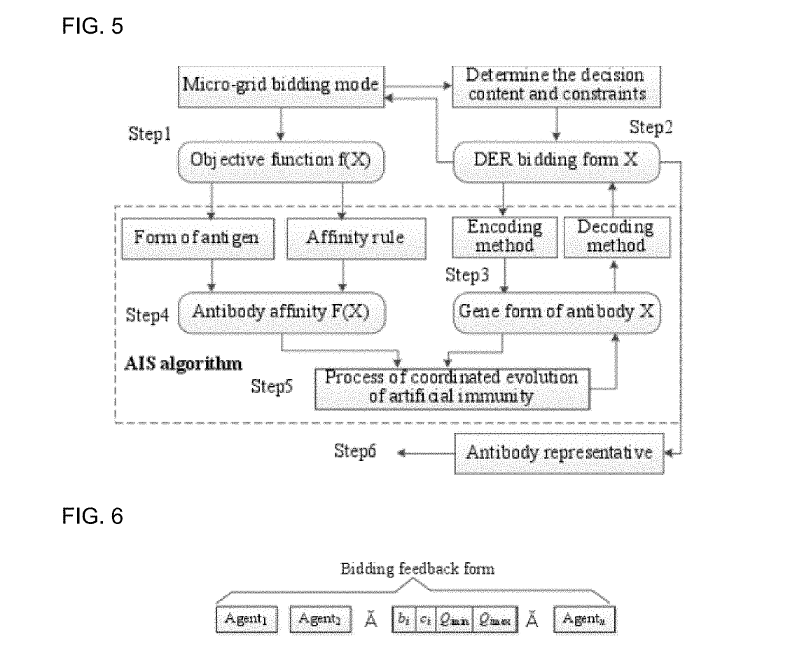

D. The Optimized Algorithm Flowchart of the Bidding Unit Multi-Agent Based on Artificial Immunity of the Embodiment is Shown in FIG. 5, and Comprises the Following Steps:

401: Determine a form of quotation and the bidding objective function based on the bidding mode of the micro-grid by the owner of DER device;

Wherein, the quotation form of the bidding unit of DER contains four parameters [bᵢ, cᵢ, Qᵢₘᵢₙ, Qᵢₘₐₓ]′ the price function and power constraint are:

Bᵢ(Qᵢ)=bᵢ+cᵢQᵢ, (1)

s.t. Qₘᵢₙ≤Qᵢ≤Qₘₐₓ (2)

Wherein, Bᵢ(Qᵢ) is the bidding price based on the generating capacity, bᵢ and cᵢ are bidding coefficients of the i^{th} DER device, which will directly determine whether the DER will be successful, and the winning generating capacity. Qᵢₘᵢₙ and Qᵢₘₐₓ represent the maximum and minimum generating capacity during the time period, which decided by the characteristics of DER device and the environment.

The objective function πᵢ(bᵢ, cᵢ) of the DER bidding unit is determined by the bidding method used by each DER device.

402: Determine the form of antigen of artificial immune algorithm according to the characteristics of DER device by the bidding unit Agent.

The form of antigen of DER bidding unit comprises: (a) environmental information of the bidding equipments, which belongs to the private information, different devices have different concerns, such as a micro-turbine concerns the price of nature gas, photovoltaic generation concerns sunlight intensity, and the wind turbine concerns the wind intensity; (b) the electricity purchase price obtained by the main grid and the selling price which is to be sold to the main grid during the optimized operation time period; and (c) quotation of other bidding unit Agent, which comprises the bidding coefficients bᵢ and cᵢ, and the maximum and minimum generating capacities. The form of the submitted bidding feedback is as shown in FIG. 6, the information may be obtained by the bidding management Agent, or obtained by information interacting among the Agents. When only the DER is allowed to participate in bidding, the number n of elements in the collection of antibody representative is the number of Agents of the bidding DER.

Wherein, environmental factors (antigen part 1) and technical parameters of respective bidding DERs determine the power generation cost and the certain period Qᵢₘᵢₙ and Qᵢₘₐₓ; electricity market purchase and selling prices P_{buy} and Pₛₑₗₗ (antigen part 2) determine upper and lower range of the clearance price p_{cl} of the micro-grid, and the price of the bidding unit Agent and bidding feedback information (antigen part 3) determine value of clearance price p_{cl} of the micro-grid, and this value is vital to bidding of the micro-grid and interest of respective participants within the micro-grid. Information interaction among the Agents is realized by submission in bidding and is released as bidding feedback to other bidding Agents.

403: Determine the antibody, encoding and decoding of the artificial immune algorithm according to the form of quotation of DER device by the bidding unit Agent.

Instead of direct operating the actual decision variable (that is the quotation of power generation) of the problem to be solved, operation of the artificial immunity algorithm realizes optimization via performing calculation such as clone, variation and selection to solvable individual code. Quotation form of the bidding DER contains four parameters [bᵢ, cᵢ, Qᵢₘᵢₙ, Qᵢₘₐₓ], the antibody of the artificial immune algorithm space corresponds to the above four parameters by encoding and decoding.

Wherein Qᵢₘᵢₙ and Qᵢₘₐₓ are concerned with environment and technical parameters of related period, and these two parameters may take no part in bidding strategy in the embodiment. As a result, the antibody as described herein only includes genetic elements bᵢ and cᵢ, and encoding of the antibody is also conducted to genetic elements bᵢ and cᵢ. The antibody encoding in the embodiment employs Gray coding, the main advantage of which is that the change between adjacent points follows to minimum character set coding principle, thus improving the local search ability of AIS method.

404: Determine the affinity formulae of the artificial immune algorithm according to the objective function of quotation of DER device by the bidding unit Agent.

The affinity of antigen and antibody represents the interest and target of the bidding unit, and also decides the strength and weakness of the antibody. The calculation of affinity is decided by bidding method adopted by DER devices.

Based on antigen, the antibody of the Agent is matured by adding the affinity. Any Agent solution space (bᵢ, cᵢ) can form an antibody Ab, and a corresponding interest πᵢ(bᵢ, cᵢ), the interest decides the affinity of antibody. In certain environment (antigen), when the bidding strategy (antibody) is able to obtain the maximum interest (object function), it is considered to achieve the largest affinity.

405: Based on the form of antigen of Step 402, process the collected information and form artificial immune environmental antigen by the bidding unit Agent.

Wherein, the information of bidding feedbacks is the only way and contents interacted among the Agents, the embodiment adopts the bidding information of the respective bidding unit Agents. The initial value of the bidding information may be reflected by the real operating costs, or may be bidding information made by a bidding strategy. Under the direction of the presented affinity, the bidding process is to obtain an optimized value based on the artificial immune algorithm. Within a same operating control time period, the bidding price submitted by the Agents are varied with iteration, thus the antigen is dynamic.

406: Based on the environmental antigen, Perform solving based on artificial immune algorithm to obtain antibody meeting interest of a DER by the bidding unit Agent; and decode the antibody to obtain a bidding scheme of DER and submit it to the bidding management Agent.

Wherein, each bidding process is an immune process. The bidding solution process can use various adaptive intelligent algorithms, including but not limited to artificial immune algorithms, genetic algorithms, etc.

During optimized operation of the micro-grid, the bidding unit Agent performs coordinated evolution and performs the steps 405 and 406.

E. The Bidding Management Agent Assists the Bidding Unit Agent of the Micro-Grid to Achieve Coordination and Optimization Via the Operations Such as Collecting and Submitting the Bidding Information, which Comprises the Following Steps:

501: Send the collected antibody representative to the bidding Agents;

502: Wait and receive the submitted bidding information by the bidding Agents in the micro-grid;

503: Determine whether the coordination of the sources and loads of DER in the micro-grid is completed, e.g., whether the sources and loads of DER in micro-grid is balanced. The determining condition includes: (a) achieving the prescribed times of coordination; (b) the coordinated clearance price in the micro-grid is unchanged;

Wherein, the permitted coordination time max_{bid} is determined according to the market rule of the micro-grid, and can take an integer with the range of 3 to 10 if multiple coordination are permitted.

504: Determine whether the coordination is completed, if yes, record the bidding information of the bidding unit, and obtain the operation scheme of the DER device to submit to the operation management Agent of the micro-grid;

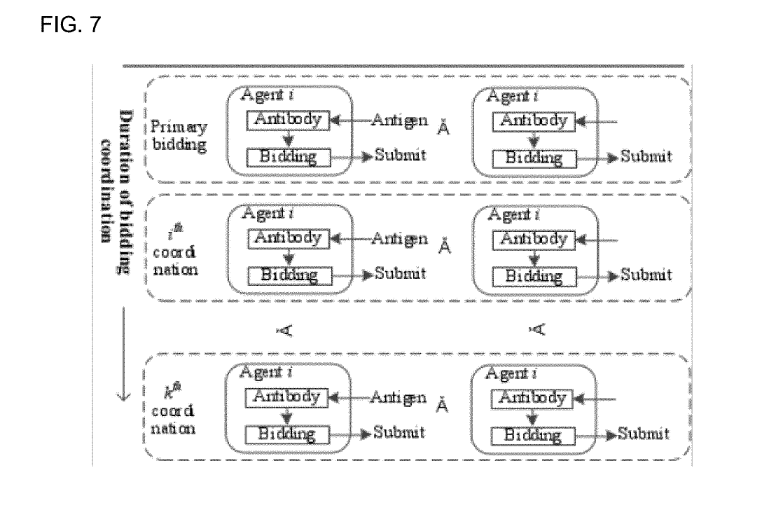

505: Determine whether the coordination is completed, if no, perform step 501 to repeat the bidding to complete coordination of the bidding unit Agents in the micro-grid. Based on the mixed centralized and distributed control method in the micro-grid, the present invention applies this release form in the present method can achieve a higher efficiency. If there exists an information interaction communication among the bidding units, the information interaction among the bidding units can be achieved without the bidding management Agent involved.

Wherein, the artificial immune algorithm is a parallel optimized calculation based on the biological immune mechanism. The above-mentioned bidding unit Agents only search for antigens in their own bidding space via the collection of antibody and the gene knowledge base. The process does not need assistance of central control, which can be done in parallel. However, the antigen of each biding unit Agent contains the bidding feedback information (such as the contents of other antibody bidding information or clearance price P_{cl}) released from the bidding management Agent, so the antigen has global nature. The micro-grid bidding process of AIS system based on coordinated evolution is shown in FIG. 7.

Embodiment of Calculation and Analysis

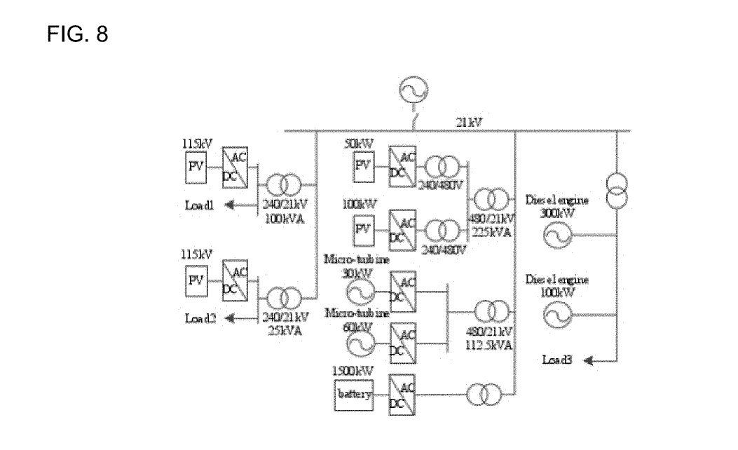

Example will be given to a commercial micro-grid project which as the system structure as shown in FIG. 8. This micro-grid includes three feeding lines, and includes different types of distributed energy resources of two micro-turbines, two diesel engines and four solar photovoltaic energies. Reactive power portion is not taken into account. The cost factors and upper and lower limits of power output of each distributed energy resource are exhibited in table 1.

TABLE 1
DER cost factors and power output limits

| | | | Minimum | Maximum | |
|---|---|---|---|---|---|
| | | Operation | electricity | electricity | |
| num- | | cost | generation | generation | Starting |
| ber | type | $/kW | amount/kW | amount/kW | fees/$ |
| 1 | Photovoltaic 1 | 0 | 0 | 115 | 0 |
| 2 | Photovoltaic 2 | 0 | 0 | 115 | 0 |
| 3 | Photovoltaic 3 | 0 | 0 | 50 | 0 |
| 4 | Photovoltaic 4 | 0 | 0 | 100 | 0 |
| 5 | Micro-turbine 1 | 0.02 | 5 | 30 | 2 |
| 6 | Micro-turbine 2 | 0.025 | 10 | 60 | 2 |
| 7 | diesel engine 1 | 0.035 | 90 | 300 | 1 |
| 8 | diesel engine 2 | 0.035 | 60 | 100 | 1 |

Assume at a certain peak time, the micro-grid purchases at price of 0.022$/kWh from the main grid and sells at price of 0.03$/kWh. As the time of each duration is constant (e.g. 15 min), it is available to replace the electricity amount with power of the micro-grid, the active power demand of three loads in this period is 130 kW, and reactive power requirement and influence of the same will not be taken into account. Default values of major operation parameters of the algorithm are: scale of antibody collection m=8, clonal scale of antibody size_{clone}=4, threshold value of mutation mode P=0.1, maximum permissible bidding times max_{bid}=5, and maximum permissible generations of antibody evolution Max_{Gen}=50.

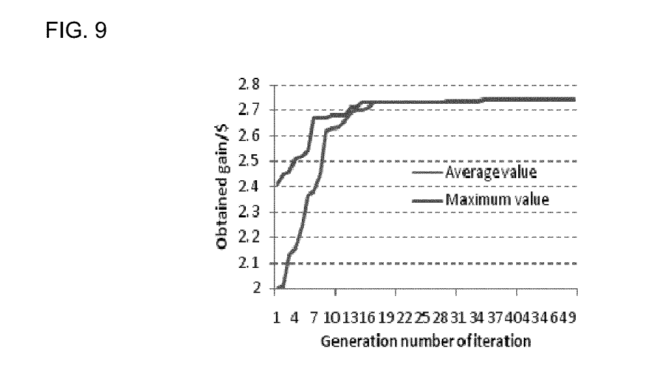

Affinity change of an antibody collection during bidding process of some Agent is illustrated in FIG. 9. In which, the horizontal axis represents evolution iteration generations of the antibody, while vertical axis represents gain (affinity) obtained by DER. Two lines shown in FIG. 9 represent the maximum and average affinity of antibody collection. It is seen from the figure that for each Agent, though antibody (bidding strategy) has affected by affinity of antigen (environmental factor and other collection of antibody representative), there exists increased tendency.

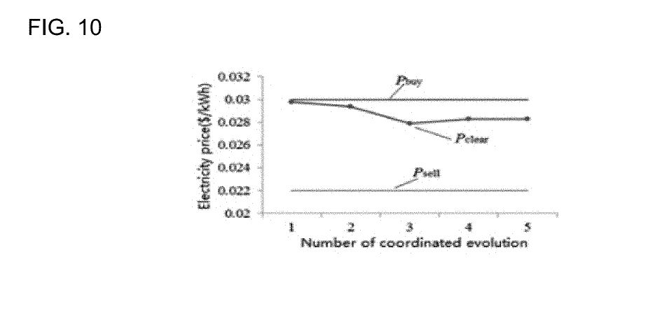

By the submission of antibody representative, coordinated evolution of respective bidding units Agents inside the micro-grid is realized. As bidding is done based on private information of respective part, this may also be done based on quotation of other Agents. As such, bidding price will rapidly converge and then reach Nash Equilibrium. Convergence of bidding price inside the micro-grid is shown in FIG. 10.

After performing electricity generation adjustment of the Agent bidding strategy, the Agent of the micro-grid is able to realize minimization cost of electricity generation and power transmission of the micro-grid while keeping maximum efficiency of photovoltaic and wind generation. The bidding result is shown in table 2.

TABLE 2
micro-grid DER operation results based on bidding

| | | Clearance | electricity | |
|---|---|---|---|---|
| | | price | generation | Obtained |
| number | type | $/kW | amount kW | gain $ |
| 1 | Photovoltaic 1 | 0.028 | 115 | 3.22 |
| 2 | Photovoltaic 2 | | 115 | 3.22 |
| 3 | Photovoltaic 3 | | 50 | 1.4 |
| 4 | Photovoltaic 4 | | 100 | 2.8 |
| 5 | Micro-turbine 1 | | 30 | 0.24 |
| 6 | Micro-turbine 2 | | 10 | 0.03 |
| 7 | diesel engine 1 | | 0 | 0 |
| 8 | diesel engine 2 | | 0 | 0 |

Note:
the obtained gain only includes gain of electricity energy, and gain of supplying heating and cooling has been deducted from DER quotation.

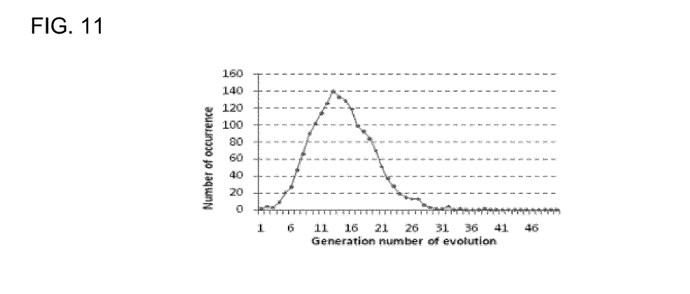

Artificial immune algorithm is a random algorithm, and operation duration of system may be different each time. The present invention makes statistical analysis on expected generation of optimal solution to be obtained by a single Agent. The system has run bidding operation for 5000 times to the micro-turbine Agent and the statistical results of self-adaptive scheme are shown in FIG. 11, wherein the horizontal axis represents number of evolution generation, whereas the vertical axis means the times (frequency) by which global optimal solution corresponding to the number of evolution generation can be found out. Seen from the figure, there is high probability within 30 generations to find out the global optimal solution, and the average generation to find out the optimal solution is 13.5 generations.

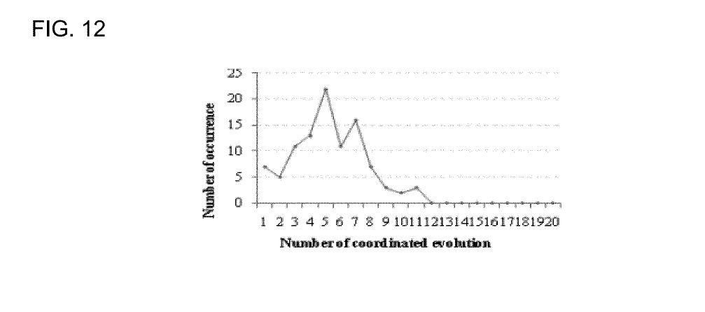

For the entire micro-grid, Nash Equilibrium will be reached after several times of coordinated evolution. FIG. 12 shows optimal result after solving on the micro-grid for 100 times of coordinated evolution. As seen from figure that the maximum expectation number is 5 by which Nash Equilibrium price can be obtained based on bidding. To save operation time, feedback and coordination times may be limited to less frequency so as to finish bidding inside the micro-grid.

The present invention runs on the basis of antibody gene knowledge base, thus guarantees quick convergence and global optimization of artificial immunity bidding scheme. The bidding process is a continuous repeating process, and abnormal accidents are far less than normal accidents during actual operation. The new antibody generated during a primary response has memory and when similar questions rise again, the optimal bidding scheme will be generated quickly by using a secondary response mechanism. In addition, respective Agents run calculation in parallel and therefore render higher efficiency.

### REFERENCES

[1] Wang Chengshan, Wu Zhen, Li Peng. Research on Key Technologies of Micro-grid [J]. 2014, 29(2): 1-12.
[2] Ai Qian, Zhang Jian. Bidding optimal strategy of the micro-grid based on multi-agent system[J]. 2010, 34(2): 46-51.
[3] Kong Xiangyu, Fang Dazhong. Study on the Electricity Bidding Model of Joint venture considering network Loss[J]. 2009, 42(2): 105-109.
[4] Song Yiqun, Gao Zhan. Technology application in electricity market[J]. 2008, 20(3): 111-116.

Person skilled in the art would have understood that the accompanied drawings are only for illustrative purposes of a preferred embodiment of the invention. The above inventive embodiments are for descriptive purposes and not reflect advantages or disadvantages of the embodiments.

Though various embodiments of the invention have been illustrated above, a person of ordinary skill in the art will understand that, variations and improvements made upon the illustrative embodiments fall within the scope of the invention, and the scope of the invention is only limited by the accompanying claims and their equivalents.

1-6. (canceled)

7. An optimized operation method in micro-grid with multi-agent structure, which comprises the following steps:
(1) the main grid obtains the electricity market purchase price P_{buy} which is to be sold to the user and DER selling price Pₛₑₗₗ at next stage after connected to the main grid;
(2) the individual DERs perform calculation of the optimized operation in the micro-grid based on bidding strategy; the DERs of the micro-grid adopt bidding unit for quotation; and the multi-agent of the bidding management assists in the completion of coordination and optimization of the units in the micro-grid;
(3) the bidding management multi-agent transmits the bidding results of each unit to the control system of the micro-grid, and the micro-grid performs optimized operation in the micro-grid based on the coordinated bidding results;
wherein the steps of “the DERs of the micro-grid adopts bidding unit for quotation” comprise:
determining affinity formula of artificial immune algorithm based on the objective function of the DER bidding unit, and forming a quotation environmental antigen of artificial immunity;
solving the artificial immune algorithm and obtaining antibody in accordance with the interest of DER, and decoding the antibody to achieve the bidding schemes of DER and submitting it to the bidding management multi-agent;
wherein the steps of “determining affinity formula of artificial immune algorithm based on the objective function of the DER bidding unit, and forming a quotation environmental antigen of artificial immunity” comprise:
(1) based on the bidding modes of the micro-grid, determining the quotation mode and bidding objective function by the owners of DERs;
(2) based on the characteristics of DER, determining the forms of antigen of artificial immune algorithm by the bidding unit multi-agent;
(3) based on the quotation mode of DER, determining antibody, encoding and decoding formulas of antibody of artificial immune algorithm by the bidding unit multi-agent;
(4) based on the objective function of the DER bidding unit, determining affinity formula of artificial immune algorithm by the bidding unit multi-agent; and
(5) processing the collected information by the bidding unit multi-agent to achieve the quotation environmental antigen.

8. The optimized operation method in micro-grid with multi-agent structure according to claim 1, wherein the steps of “the bidding management multi-agent assists in the completion of coordination and optimization of units in the micro-grid” comprise:
determining whether the resources and loads of DER in micro-grid are balanced;
if yes, recording the bidding information of DERs, generating the generator operation scheme and submitting it to the control system of micro-grid;
otherwise, performing bidding until the resources and loads of DER in micro-grid achieves balance.

9. The optimized operation method in micro-grid with multi-agent structure according to claim 1, wherein the form of antigen comprises the followings three information
(a) environmental information of the bidding equipments;
(b) the electricity purchase price obtained by the main grid and the selling price which is to be sold to the main grid;
(c) quotation of other bidding unit multi-agent.

10. The optimized operation method in micro-grid with multi-agent structure according to claim 2, wherein the determination condition is:
(a) achieving the maximum processing number of coordination; (b) the coordinated clearance price in the micro-grid is unchanged.
